(19) United States
(12) Patent Application Publication
(10) Pub. No.: US 2014/0268727 A1
(43) Pub. Date: Sep. 18, 2014

(54) DIFFUSERS FOR LED-BASED LIGHTS

(71) Applicant: iLumisys, Inc., Troy, MI (US)

(72) Inventors: James Meredith Amrine, JR., Ann Arbor, MI (US); Allan Brent York, JR., Langley (CA)

(73) Assignee: iLumisys, Inc., Troy, MI (US)

(21) Appl. No.: 14/208,403

(22) Filed: Mar. 13, 2014

Related U.S. Application Data
(60) Provisional application No. 61/783,217, filed on Mar. 14, 2013.
(60) Provisional application No. 61/846,712, filed on Jul. 16, 2013.

(51) Int. Cl. F21K 99/00

(52) U.S. Cl. CPC F21K 9/17; F21K 9/50; F21K 9/58
USPC 362/224

(57) ABSTRACT

An LED-based light assembly includes a plurality of LEDs and an elongate housing for the LEDs. The housing has an outer surface at least partially defined by a first lens. The assembly also includes a second lens. The second lens is removably attachable to the outer surface of the housing such that at least a portion of the second lens overlays the first lens in a spaced relationship. The assembly further includes at least one connector arranged at an end of the housing that configured for engagement with a socket of a fluorescent light fixture.

### CROSS REFERENCE TO RELATED APPLICATIONS

This application claims priority to U.S. Provisional Patent Application No. 61/783,217 filed Mar. 14, 2013 and U.S. Provisional Patent Application No. 61/846,712 filed Jul. 16, 2013, the entire contents of which are incorporated herein by reference.

### TECHNICAL FIELD

This disclosure relates to light emitting diode (LED)-based lights for replacing conventional lights in standard light fixtures and more particularly to diffusers for such lights.

### BACKGROUND

Fluorescent lights are widely used in a variety of locations, such as schools and office buildings. Although conventional fluorescent lights have certain advantages over, for example, incandescent lights, they also pose certain disadvantages including, inter alia, disposal problems due to the presence of toxic materials within the light.

LED-based lights designed as one-for-one replacements for fluorescent lights have appeared in recent years. LED-based lights have also been developed for use as replacements for incandescent bulbs.

### SUMMARY

Disclosed herein are a system, method and apparatus for diffusing the light of an LED-based light that includes a lens by affixing a second lens to the LED-based light. In one aspect, an LED-based light assembly comprises a plurality of LEDs; an elongate housing for the LEDs, the housing having an outer surface at least partially defined by a first lens; a second lens, the second lens removably attachable to the outer surface of the housing such that at least a portion of the second lens overlays the first lens in a spaced relationship; and at least one connector arranged at an end of the housing, the connector configured for engagement with a socket of a fluorescent light fixture.

In another aspect, a method of modifying the light diffusion characteristics of an LED-based light with a plurality of LEDs, an elongate housing for the LEDs having an outer surface at least partially defined by a first lens, and at least one connector arranged at an end of the housing configured for engagement with a socket of a fluorescent light fixture comprises removably attaching a second lens to the outer surface of the housing, such that at least a portion of the second lens overlays the first lens in a spaced relationship.

In yet another aspect, an LED-based light assembly comprises a plurality of LEDs; an elongate housing for the LEDs, the housing having an outer surface at least partially defined by a first lens and defining a first groove on a first side of the lens and a second groove on an opposing side of the lens, with the first groove bordered by a first edge of the outer surface and the second groove bordered by a second edge of the outer surface; a second lens, the second lens having two opposing end portions and an interior surface extending between the two end portions, with first and second opposing pairs of spaced tabs projecting radially inwardly from the interior surface, wherein the second lens is resiliently flexible such that the second lens is configured to be arranged around the outer surface of the housing in at least one of: a first attachment position, where the first pair of spaced tabs is positioned in the first groove, the second pair of spaced tabs is positioned in the second groove, and at least a portion of the second lens overlays the first lens in a first spaced relationship, or a second attachment position, the first pair of spaced tabs is positioned on both sides of the first edge, the second pair of spaced tabs is positioned on both sides of the second edge, and at least a portion of the second lens overlays the first lens in a second spaced relationship different from the first spaced relationship; and at least one connector arranged at an end of the housing, the connector configured for engagement with a socket of a fluorescent light fixture.

Variations in these and other aspects of this disclosure will be described in additional detail hereafter.

### BRIEF DESCRIPTION OF THE DRAWINGS

The various features, advantages and other uses of the present system and method will become more apparent by referring to the following detailed description and drawings in which:

FIG. 1 is a perspective view of an example of an LED-based light;

FIG. 2 is a perspective assembly view of the LED-based light of FIG. 1 showing a housing including a lower portion and a lens, an LED circuit board, a power supply circuit board and a pair of end caps;

FIG. 3 is a cross-section of an example of a diffuser for the LED-based light in accordance with one disclosed implementation;

FIG. 4 is a perspective view of the LED-based light with the diffuser in accordance with FIG. 3;

FIGS. 5a-h are cross-sectional views of different examples of diffusers for the LED-based light;

FIG. 6 is a cross-sectional view of the LED-based light;

FIG. 7. is a cross-sectional view of the LED-based light with a primary diffuser, showing light rays;

FIG. 8 is a cross-sectional view of the LED-based light with a secondary diffuser in a first position;

FIG. 9. is a cross-sectional view of the LED-based light with a secondary diffuser in a first position, showing light rays; and

FIG. 10 is a cross-sectional view of the LED-based light with a secondary diffuser in a second position.

### DETAILED DESCRIPTION

FIGS. 1 and 2 illustrate an LED-based light 10 for replacing a conventional light in a standard light fixture. LED-based light 10 includes a housing 12 and has a pair of end caps 20 positioned at the ends of housing 12. An LED circuit board 30 including LEDs 34 and a power supply circuit board 32 are arranged within housing 12.

Housing 12 can generally define a single package sized for use in a standard fluorescent light fixture. In the illustrated example, the pair of end caps 20 is attached at opposing longitudinal ends of housing 12 for physically connecting LED-based light 10 to a light fixture. As shown, each end cap 20 carries an electrical connector 18 configured to physically connect to the light fixture. Electrical connectors 18 can be the sole physical connection between LED-based light 10 and the light fixture. One example of a light fixture for the LED-based light 10 is a troffer designed to accept conventional fluorescent lights, such as T5, T8 or T12 fluorescent tube lights. These and other light fixtures for LED-based light 10 can include one or more sockets adapted for physical engagement with electrical connectors 18. Each of the illustrated electrical connectors 18 is a bi-pin connector including two pins 22. Bi-pin electrical connectors 18 are compatible with many fluorescent light fixtures and sockets, although other types of electrical connectors can be used, such as a single pin connector or a screw type connector.

The light fixture for LED-based light 10 can connect to a power source, and at least one of electrical connectors 18 can additionally electrically connect LED-based light 10 to the light fixture to provide power to LED-based light 10. In this example, each electrical connector 18 can include two pins 22, although two of the total four pins can be “dummy pins” that provide physical but not electrical connection to the light fixture. The light fixture can optionally include a ballast for electrical connection between the power source and LED-based light 10.

While the illustrated housing 12 is cylindrical, a housing having a square, triangular, polygonal, or other cross-sectional shape can alternatively be used. Similarly, while the illustrated housing 12 is linear, housings having an alternative shape, e.g., a U-shape or a circular shape can alternatively be used. LED-based light 10 can have any suitable length. For example, LED-based light 10 may be approximately 48″ long, and housing 12 can have a 0.625″, 1.0″ or 1.5″ diameter for engagement with a standard fluorescent light fixture.

Housing 12 can be formed by attaching multiple individual parts, not all of which need be light transmitting. For example, the illustrated example of housing 12 is formed in part by attaching a lens 14 at least partially defining housing 12 to an opaque lower portion 16. The illustrated housing 12 has a generally bipartite configuration defining a first cavity 50 between lower portion 16 and lens 14 sized and shaped for housing LED circuit board 30 and a second cavity 60 defined by lower portion 16 sized and shaped for housing power supply circuit board 32.

As shown, the lower portion 16 defines an LED mounting surface 52 for supporting LED circuit board 30. LED mounting surface 52 can be substantially flat, so as to support a flat underside of LED circuit board 30 opposite the LEDs 34. After attachment of lens 14 to lower portion 16 during assembly of LED-based light 10, LED circuit board 30 is positioned within first cavity 50 and adjacent lens 14, such that LEDs 34 of LED circuit board 30 are oriented to illuminate lens 14.

The illustrated lower portion 16 has a tubular construction to define second cavity 60, although lower portion 16 could be otherwise configured to define a cavity configured for housing power supply circuit board 32. LED-based light 10 can include features for supporting power supply circuit board 32 within second cavity 60. For example, as shown, an end cap 20 may include channels 62 configured to slidably receive outboard portions of an end 32a of power supply circuit board 32. It will be understood that channels 62 are provided as a non-limiting example and that power supply circuit board 32 may be otherwise and/or additionally supported within second cavity 60.

Lower portion 16 may be constructed from a thermally conductive material and configured as a heat sink to enhance dissipation of heat generated by LEDs 34 during operation to an ambient environment surrounding LED-based light 10. In exemplary LED-based light 10, an LED mounting surface 52 of lower portion 16 is thermally coupled to LEDs 34 through LED circuit board 30, and the remainder of lower portion 16 defines a heat transfer path from LED mounting surface 52 to the ambient environment.

Lower portion 16 and lens 14 may each include complementary structures permitting for attachment of lens 14 to lower portion 16 to define first cavity 50. For example, as shown, lower portion 16 may include a pair of hooked projections 54 for retaining a corresponding pair of projections 56 of lens 14. Projections 56 of lens 14 can be slidably engaged with hooked projections 54 of lower portion 16, or can be snap fit to hooked projections 54. Hooked projections 54 can be formed integrally with lower portion 16 by, for example, extruding lower portion 16 to include hooked projections 54. Similarly, projections 56 can be formed integrally with lens 14 by, for example, extruding lens 14 to include projections 56. Hooked projections 54 and projections 56 can extend the longitudinal lengths of lower portion 16 and lens 14, respectively, although a number of discrete hooked projections 54 and/or projections 56 could be used to couple lens 14 to lower portion 16. Alternatively, lower portion 16 could be otherwise configured for attachment with lens 14. For example, lens 14 could be clipped, adhered, snap- or friction-fit, screwed or otherwise attached to lower portion 16.

Alternatively to the illustrated housing 12, housing 12 can include a light transmitting tube at least partially defined by lens 14. Lens 14 can be made from polycarbonate, acrylic, glass or other light transmitting material (i.e., lens 14 can be transparent or translucent). The term “lens” as used herein means a light transmitting structure, and not necessarily a structure for concentrating or diverging light.

LED-based light 10 can include features for distributing the light produced by LEDs 34 to, for example, emulate in full or in part the uniform light distribution of a conventional fluorescent light. For instance, lens 14 can be manufactured to include light diffusing structures, such as ridges, dots, bumps, dimples or other uneven surfaces formed on an interior or exterior of lens 14. The light diffusing structures can be formed integrally with lens 14, for example, by molding or extruding, or the structures can be formed in a separate manufacturing step such as surface roughening. Alternatively, the material from which lens 14 is formed can include light refracting particles. For example, lens 14 can be made from a composite, such as polycarbonate, with particles of a light refracting material interspersed in the polycarbonate. In addition to or as an alternative to these light diffusing structures, a light diffusing film can be applied to the exterior of lens 14 or placed in housing 12.

LED-based light 10 can include other features for distributing light produced by LEDs 34. For example, lens 14 can be manufactured with structures to collimate light produced by LEDs 34. The light collimating structures can be formed integrally with lens 14, for example, or can be formed in a separate manufacturing step. In addition to or as an alternative to manufacturing lens 14 to include light collimating structures, a light collimating film can be applied to the exterior of lens 14 or placed in housing 12.

In yet other embodiments, LEDs 34 can be over molded or otherwise encapsulated with light transmitting material configured to distribute light produced by LEDs 34. For example, the light transmitting material can be configured to diffuse, refract, collimate and/or otherwise distribute the light produced by LEDs 34. Over molded LEDs 34 can be used alone to achieve a desired light distribution for LED-based light 10, or can be implemented in combination with lens 14 and/or films described above.

The above described or other light distributing features can be implemented uniformly or non-uniformly along a length and/or circumference of the LED-based light 10. These features are provided as non-limiting examples, and in other embodiments, the LED-based light 10 may not include any light distributing features.

LED circuit board 30 can include at least one LED 34, a plurality of series-connected or parallel-connected LEDs 34, an array of LEDs 34 or any other arrangement of LEDs 34. Each of the illustrated LEDs 34 can include a single diode or multiple diodes, such as a package of diodes producing light that appears to an ordinary observer as coming from a single source. LEDs 34 can be surface-mount devices of a type available from Nichia, although other types of LEDs can alternatively be used. For example, LED-based light 10 can include high-brightness semiconductor LEDs, organic light emitting diodes (OLEDs), semiconductor dies that produce light in response to current, light emitting polymers, electro-luminescent strips (EL) or the like. LEDs 34 can emit white light. However, LEDs that emit blue light, ultra-violet light or other wavelengths of light can be used in place of or in combination with white light emitting LEDs 34.

The orientation, number and spacing of LEDs 34 can be a function of a length of LED-based light 10, a desired lumen output of LED-based light 10, the wattage of LEDs 34, a desired light distribution for LED-based light 10 and/or the viewing angle of LEDs 34.

LEDs 34 can be fixedly or variably oriented in LED-based light 10 for facing or partially facing an environment to be illuminated when LED-based light 10 is installed in a light fixture. Alternatively, LEDs 34 can be oriented to partially or fully face away from the environment to be illuminated. In this alternative example, LED-based light 10 and/or a light fixture for LED-based light 10 may include features for reflecting or otherwise redirecting the light produced by the LEDs into the environment to be illuminated.

For a 48″ LED-based light 10, the number of LEDs 34 may vary from about thirty to sixty such that LED-based light 10 outputs approximately 3,000 lumens. However, a different number of LEDs 34 can alternatively be used, and LED-based light 10 can output any other amount of lumens.

LEDs 34 can be arranged in a single longitudinally extending row along a central portion of LED circuit board 30 as shown, or can be arranged in a plurality of rows or arranged in groups. LEDs 34 can be spaced along LED circuit board 30 and arranged on LED circuit board 30 to substantially fill a space along a length of lens 14 between end caps 20 positioned at opposing longitudinal ends of housing 12. The spacing of LEDs 34 can be determined based on, for example, the light distribution of each LED 34 and the number of LEDs 34. The spacing of LEDs 34 can be chosen so that light output by LEDs 34 is uniform or non-uniform along a length of lens 14. In one implementation, one or more additional LEDs 34 can be located at one or both ends of LED-based light 10 so that an intensity of light output at lens 14 is relatively greater at the one or more ends of LED-based light 10. Alternatively, or in addition to spacing LEDs 34 as described above, LEDs 34 nearer one or both ends of LED-based light 10 can be configured to output relatively more light than the other LEDs 34. For instance, LEDs 34 nearer one or both ends of LED-based light 10 can have a higher light output capacity and/or can be provided with more power during operation.

Power supply circuit board 32 is positioned within housing 12 adjacent electrical connector 18 and has power supply circuitry configured to condition an input power received from, for example, the light fixture through electrical connector 18, to a power usable by and suitable for LEDs 34. In some implementations, power supply circuit board 32 can include one or more of an inrush protection circuit, a surge suppressor circuit, a noise filter circuit, a rectifier circuit, a main filter circuit, a current regulator circuit and a shunt voltage regulator circuit. Power supply circuit board 32 can be suitably designed to receive a wide range of currents and/or voltages from a power source and convert them to a power usable by LEDs 34.

LED-based light 10 may require a number of electrical connections to convey power between the various illustrated spatially distributed electrical assemblies included in LED-based light 10, such as LED circuit board 30, power supply circuit board 32 and electrical connector 18. These connections can be made using a circuit connector header 40 and a pin connector header 42, as shown in FIG. 2. In particular, when LED-based light 10 is assembled, circuit connector header 40 may be arranged to electrically couple LED circuit board 30 to power supply circuit board 32, and pin connector header 42 may be arranged to electrically couple power supply circuit board 32 to pins 22 of an end cap 20.

As shown, LED circuit board 30 the power supply circuit board 32 are vertically opposed and spaced with respect to one another within housing 12. LED circuit board 30 and power supply circuit board 32 can extend a length or a partial length of housing 12, and LED circuit board 30 can have a length different from a length of power supply circuit board 32. For example, LED circuit board 30 can generally extend a substantial length of housing 12, and power supply circuit board 32 can extend a partial length of housing 12. However, it will be understood that LED circuit board 30 and/or power supply circuit board 32 could be alternatively arranged within housing 12, and that LED circuit board 30 and power supply circuit board 32 could be alternatively spaced and/or sized with respect to one another.

LED circuit board 30 and power supply circuit board 32 are illustrated as elongate printed circuit boards. Multiple circuit board sections can be joined by bridge connectors to create LED circuit board 30 and/or power supply circuit board 32. Also, other types of circuit boards may be used, such as a metal core circuit board. Further, the components of LED circuit board 30 and power supply circuit board 32 could be on a single circuit board or more than two circuit boards.

LED-based lights are often used in lighting fixtures that require four or more lighting tubes each. Some lighting fixtures include diffusers, however, in other cases, the lighting fixtures do not include diffusers or include diffusers that were designed for non-LED-based lights, such as fluorescent lights, and may not diffuse light well enough to work with LED-based lights. In these lighting fixtures, the spacing between multiple LED-based lights can create “hot spots” at locations corresponding to the positions of the LED-based lights on production of light by the LEDs. In addition, because the LED-based lights are generally more efficient sources of light compared to the fluorescent lights, it is contemplated that one or more of the total lights in a lighting fixture may be eliminated during a retrofit replacement of fluorescent lights with LED-based lights. This in turn may accentuate the existence and appearance of hot spots. Aspects of disclosed implementations provide diffusors to work with LED-based lights by attaching directly to the light without requiring fasteners or adhesives. These diffusers can be attached to LED-based lights without additional diffusers or in conjunction with existing diffusers.

The diffusers disclosed herein can be attached directly to LED-based lights without any additional fixtures, fasteners or adhesives. The diffusers disclosed herein can be slipped or snapped on to the LED-based light without tools and may be held in place by tabs on the diffuser fitting into a groove or grooves on the LED-based light where friction between the diffuser tabs and the LED-based light keeps the diffuser in place. This is in contrast to diffusers that are manufactured to attach to light fixtures or ceiling panels, for example. Diffusers manufactured to attach to light fixtures or ceiling panels cannot be used to attach directly to an LED-based light because the size, shape and elasticity of these diffusers do not permit them to be attached to the LED-based light and held in position without fasteners or adhesives.

Particularly where LED-based lights are used in lighting fixtures having no diffuser, the teachings herein provide diffusing capability to the LED-based light by providing a diffuser that can be attached to an LED-based light. The diffusers may be attached to an LED-based light without requiring fasteners or adhesives. The diffuser can be attached and detached without tools to permit the diffuser to be removed, for example, from a burned-out light and/or attached to the new replacement light.

The diffusers, although according to the examples may have different cross-sections and sizes, are each sized and shaped to permit the diffuser to be affixed to an LED-based light that already has a lens, a way of maintaining their position on an LED-based light once slid or snapped into place and sufficient surface area to cover the lens so as to diffuse the light being emitted from the LED-based light to which the LED-based light is affixed. In certain embodiments, it is desirable that the diffusers be flexible to permit the diffuser to be deformed while being snap-fit to the LED-based light. In these cases, the diffuser could be removed and exchanged, such as to change the appearance of the emitted light. In other cases, such as where the diffusers are slid on, removal of the LED-based light from its fixture may be required to remove and/or replace the diffuser.

FIG. 3 shows a cross-sectional view of a diffuser 300 designed to attach to an LED-based light such as LED-based light 10. Diffuser 300 includes a curved section 302 of diffusing material, which can be opalescent or otherwise frosted translucent plastic material. Diffuser 300 can also be made of plastic material embossed with a pattern that diffuses light. Diffuser 300 has a generally constant curved cross sectional profile with a radius of curvature R1. Diffuser 300 also includes tabs 304 formed at an interior surface of diffuser 300 that can be molded into diffuser 300 to attach diffuser 300 to an LED-based light. As shown, tabs 304 project radially inward from curved section 302 to provide two or more points of attachment to an LED-based light. Diffuser 300 may be made of any suitable plastic or other material having the properties of being transparent or translucent to visible wavelengths of light, flexible enough to snap onto an LED-based light and sturdy enough to provide adequate service life.

Diffuser 300 can have a generally open cross sectional profile and can be manually forced to an open position by bending it open in the direction of the arrows A and B to permit diffuser 300 to be placed over an LED-based light and then released to attach the diffuser 300 to the LED-based light. Once diffuser 300 is bent open in the direction of the arrows A and B and placed over the LED-based light, diffuser 300 can be released to permit tabs 304 to assume their normal position, thereby forming a friction fit to the LED-based light. In a normal position, diffuser 300 is designed so that distance “C” between the tabs 304 is sized to be slightly smaller than the width of the LED-based light, so that when diffuser 300 is released, diffuser 300 will be held onto the LED-based light by the friction between tabs 304 and the LED-based light. When diffuser 300 is assembled with the LED-based light, tabs 304 on diffuser 300 may fit into recesses on the sides of the LED-based light. Diffuser 300 can be manufactured from a resilient material that permits the diffuser to be bent open to permit diffuser 300 to be put into position over the LED-based light and then released to allow the tabs of the diffuser to contact the LED-based light. The dimensions of diffuser 300 are specified to permit diffuser 300 to be bent open to fit into position on the LED-based light and when released hold the LED-based light firmly enough to keep diffuser 300 in position without slipping off or out of position.

FIG. 4 shows an LED-based light assembly 400 including an LED-based light 402 having a diffuser 404. LED-based light 402 conforms to the configuration of FIGS. 1 and 2 in this example. Diffuser 404 is attached to LED-based light 402 by bending diffuser 404 open to permit tabs 408 of diffuser 404 to be placed over housing 406 and released to fit tabs 408 into a groove 410 in housing 406. The elasticity of the plastic material of which diffuser 404 is made can cause tabs 408 to fit tightly in groove 410 of housing 406 and thereby affix diffuser 404 to LED-based light 402 without using fasteners or adhesive. In this way, diffuser 400 is snap-fit on to LED-based light 402. To remove diffuser 400 from LED-based light 402, diffuser 400 is bent open to permit tabs 408 to be removed from groove 410 in housing 406. In an alternative implementation, diffuser 404 may be slid into groove 410 in whole or in part instead of being snap-fit with groove 410. Light from LEDs of LED-based light assembly 400 pass through the lens and then diffuser 404 to affect the characteristics of the emitted light.

FIGS. 5a -5h show cross-sectional views of various diffusers that can be used in accordance with the teachings herein. As described above in connection with diffuser 300 shown in FIG. 3, diffusers may be manufactured in various colors and textures, including transparent and translucent colors such as opal. They may also have surface effects and/or coatings as described above with regard to lens 14. It will be understood that these diffusers may also be attached to an LED-based light in a similar manner as that described above for diffuser 300.

FIG. 5a shows a diffuser 500a. Similarly to diffuser 300, diffuser 500a includes a curved section 502a of diffusing material. Differently from diffuser 300, curved section 502a of diffuser 500a is less rounded than curved section 302. In particular, curved section 502a of diffuser 500a has a slightly elongated curved cross sectional profile, with a radius of curvature R1a being larger than radius of curvature R2a. Diffuser 500a also includes tabs 504a that can be molded into diffuser 500a to attach diffuser 500a to an LED-based light. As shown, tabs 504a generally taper to a blunt point as they project radially inward from curved section 502a.

FIG. 5b shows a diffuser 500b. Diffuser 500b is similar to diffuser 500a from FIG. 5a, with a curved section 502b of diffusing material. In diffuser 500b, however, tabs 504b are generally rounded. FIG. 5c shows a diffuser 500c that, similarly to diffusers 500a and 500b, includes a curved section 502c of diffusing material. In diffuser 500c, however, tabs 504c do not taper radially inward as they project radially inward from curved section 502c and are not rounded. Instead, as shown, tabs 504c have generally straight, parallel opposing walls. In addition, in diffuser 500c of FIG. 5c, tabs 504c are slightly folded under, or angled towards curved section 502c, to permit diffuser 500c to be securely engaged to an LED-based light.

FIGS. 5d, 5e and 5f show examples of diffusers with light diffusing structures molded into an interior surface of the curved section of the diffuser. In the examples, the light diffusing structures are longitudinally extending ridges that may, for example, be formed into the diffusers during an extrusion process. As explained below, the ridges can have different thicknesses, as defined by a distance between the peaks of the ridges and an opposing outer surface of the curved section.

FIG. 5d shows a diffuser 500d. Diffuser 500d is similar to diffuser 500b from FIG. 5b, with a curved section 502d of diffusing material and generally rounded tabs 504d. Diffuser 500d further includes ridges 506d formed on an interior surface of the curved section 502d. In diffuser 500d, ridges 506d have a thickness defined by a distance Dd between the peaks of the ridges 506d and an opposing outer surface of curved section 502d.

FIG. 5e shows a diffuser 500e. Diffuser 500e is also similar to diffuser 500b from FIG. 5b, with a curved section 502e of diffusing material and generally rounded tabs 504e. Diffuser 500e further includes ridges 506e formed on an interior surface of the curved section 502e. In diffuser 500e, ridges 506e have a thickness defined by a distance De between the peaks of the ridges 506e and an opposing outer surface of curved section 502e. It can be seen that in diffuser 500e, distance De is larger than distance Dd in diffuser 500d from FIG. 5d.

FIG. 5f shows a diffuser 500f. Diffuser 500f is similar to diffuser 500b from FIG. 5b, with a curved section 502f of diffusing material and generally rounded tabs 504f. In diffuser 500f, however, the cross sectional profile of curved section 502f is slightly shallower than that of curved section 502b of diffuser 500b from FIG. 5b. Diffuser 500f further includes ridges 506f formed on an interior surface of the curved section 502f. In diffuser 500f, ridges 506f have a thickness defined by a distance Df between the peaks of the ridges 506f and an opposing outer surface of curved section 502f.

FIG. 5g shows a diffuser 500g having a curved section 502g of diffusing material with a generally elliptical cross sectional profile. Diffuser 500g includes tabs 504g molded into its base to fit grooves in an LED-based light to prevent diffuser 500g from shifting when it is attached to the LED-based light. The overall shape and size of diffuser 500g may be such that it encompasses almost an entirety of the surface of a housing of an LED-based light, instead of being arranged to encompass only one portion of the surface, such as to encompass a relatively small lens area. Diffuser 500g, therefore, although it may be used with various LED-based light designs, can be particularly useful where the LED-based light has a large lens.

FIG. 5h shows a diffuser 500g having a curved section 502g of diffusing material with a generally elliptical cross sectional profile similarly to diffuser 500f in FIG. 5f. However, diffuser 500h includes end portions 516h on each side of diffuser 500h having first ribs, or tabs 516h and second ribs, or tabs 518h. The overall shape and size of diffuser 500h may be such that it encompasses almost an entirety of the surface of a housing of an LED-based light, instead of being arranged to encompass only one portion of the surface, such as to encompass a relatively small lens area. Diffuser 500h, therefore, although it may be used with various LED-based light designs, can be particularly useful where the LED-based light has a large lens.

FIG. 6 shows a cross-section of the LED-based light 402 of FIG. 4 more clearly showing grooves 410 defined at an outer surface of housing 406 that may, in some cases, accept the tabs of a diffuser. A diffuser may be held in place by the friction of tabs against the outer surface of LED-based light 402. In such implementations, the ability of the diffuser to remain in place is a function of the resilience of the diffuser material and the dimensions of the diffuser, which cause the tabs of the diffuser to be held against LED-based light 402 by friction, thereby eliminating the need for fasteners or adhesives to hold the diffuser in place. Fasteners and adhesives may also be omitted when diffusers are slid over all or part of the housing of an LED-based light. Possibly, although less desirably, diffuser may be a closed shape that encompasses the entire surface of LED-based light 402. Note that FIG. 6 also illustrates a circuit board 422 that supports LEDs 424 and extends the length of housing 406. Lens 420 is slid or snap-fit on to housing 406.

FIG. 7 shows a cross-sectional view of an LED-based light 700 having a built-in primary diffuser or lens 712. LED-based light 700, in this example, has a form similar to that in FIGS. 1 and 2. A housing 702 has a groove 704 on opposing sides and an edge 706 on at least the upper end of groove 704 formed between groove 714 and a remainder of housing 702. LED-based light 700 has a circuit board 708 upon which LEDs 710 are mounted. LEDs 710 emit light, several rays 714 of which are illustrated. Light rays 714 can be emitted by LEDs 710 to pass through primary diffuser 712. Diffuser 712 diffuses light rays 714 passing through it as shown in FIG. 7, thereby diffusing the point-source LED light into a more pleasing diffuse light.

FIG. 8 shows an LED-based light 800 having a primary diffuser or lens 812 and a secondary diffuser 814. In this example, LED-base light 800 has a structure similar to that shown in FIG. 7, including a housing 802 with grooves 804 and edges 806 and a circuit board 808 and LEDs 810 that emit light through primary diffuser 812.

In general, in diffusing the light emanating from a light source with an angular spread, such as LEDs 810, a diffusing lens can effectively utilize the extent to which the light emanating from LEDs 810 is already spread, either over space, by a diffuser, or both. Thus, for LEDs 810 with a given spread, the effectiveness of a diffuser in diffusing the light emanating from LEDs 810 of LED-based light 800 is a product of, among other things, the proximity of the diffuser to LEDs 800.

LED-based light 800 also has secondary diffuser 814 having end portions 816 on each side of secondary diffuser 814 having first ribs, or tabs 818 and second ribs, or tabs 820. The radially outward spacing of secondary diffuser 814 with respect to primary diffuser or lens 812 allows for greater diffusion of the light emanating from LEDs 810, as compared, for example, to primary diffuser or lens 812 in illustrated LED-based light 800 or lenses in other LED-based lights that similarly fall along the cross sectional profile of a fluorescent light. Since this is a cross-sectional view, ribs 818, 820 can extend in the direction in and out of the page. Secondary diffuser 814 can be made of a flexible, transparent or translucent material, for example plastic, which can transmit light and maintain sufficient flexibility to permit secondary diffuser 814 to be attached to housing 802 without requiring fasteners or adhesives. The surface of primary diffuser 812 and secondary diffuser 814 can be embossed or molded with features that diffuse light, such as ridges or surface finishes that diffuse light such as frosting.

Secondary diffuser 814 is made having a size such that end portions 816 can be bent slightly outwards permitting first ribs 818 fit over edges 806. When released, secondary diffuser 814 attempts to return to its original dimensions and thereby grips housing 802 with first 818 and second 820 ribs on either side of edges 806. Secondary diffuser 814 stays in position with respect to housing 802 and LEDs 810 through friction between first 818 and second 820 ribs and housing 802.

FIG. 9 shows LED-based light 800 from FIG. 8 having LEDs 810 that emit light rays 902 that pass through primary diffuser 812 and secondary diffuser 814 before being emitted from LED-based light 800. As can be seen from FIG. 9, light rays 902 from LEDs 810 is diffused by primary diffuser 812 and then further diffused by secondary diffuser 814. Adding secondary diffuser 814 permits LED-based light 800 to emit light more diffusely than is available with only primary diffuser 812 without requiring any additional fixtures or diffusers to be added.

FIG. 10 shows an LED-based light 1000 having a primary diffuser 1012 and a secondary diffuser 1014. LED-base light 1000 has a structure similar to that shown in FIG. 7, with a housing 1002 having grooves 1004 and edges 1006 and a circuit board 1008 and LEDs 1010 that emit light through primary diffuser 1012. LED-based light 800 also has secondary diffuser 1014 with end portions 1016 having first ribs 1018 and second ribs 1020. Secondary diffuser 1014 thus has a structure similar to that shown in FIGS. 8 and 9. In this case, end portions 1016 have been bent open to permit first ribs 1018 and second ribs 1020 to fit over edges 1006 of groves 1004 and into grooves 1004. Friction between ribs 1018, 1020 and housing 1002 including grooves 1004 and edges 1006 can prevent secondary diffuser 1014 from moving with respect to LED-based light 1000.

Adjusting a secondary diffuser from the position of diffuser 814 in FIG. 8 to the position of diffuser 1014 in FIG. 10 can change the appearance of the LED-based light. Moving the diffuser closer as shown in FIG. 10 can increase light output over a larger area than the arrangement shown in FIGS. 8 and 9 at the expense, however, of providing somewhat less diffusion. This provides an example in which the light output from the LED-based light can exceed a 180-degree scope, extending backwards significantly to describe an arc of 320 degrees or so, by virtue of the diffuser width exceeding the width of the LED replacement lamp housing.

In some implementations, a secondary diffuser may have surface treatments or other features that change the pattern of light that would otherwise be emitted from the lens of the LED-based light. In other words, the diffuser may be inhomogeneous in reflectivity and/or transmission, instead of providing uniform diffuse light. Changes in the emitted light pattern may be achieved by applying an opaque and/or reflective material to the diffuser by adhesion or by painting or by having a change to one or more sections of the surface of the diffuser itself. In one implementation, portions of the diffusing surface may be covered with an opaque material to block portions of the light being emitted from the LEDs through that portion. For example, a central reflection strip (i.e., one made of a reflective material such as aluminized mylar) may be applied to the length of an interior central portion of the secondary diffuser to prevent light from being emitted directly downwards, thereby making the LED-based light an indirect light source. Similarly, one or more variable internal reflectors may move light around the LED-based light to create a variety of emission patterns. The change in emission pattern may be created by forming one or more sections of the diffuser with a texture that changes the appearance of the emitted light in a localized area of the diffuser. Changes in the emission light pattern may also be achieved by the use of additional optical control films such as multi-layer dielectric reflectors, etc.

While the invention has been described in connection with certain embodiments, it is to be understood that the invention is not to be limited to the disclosed embodiments. On the contrary, the invention is intended to cover various modifications and equivalent arrangements included within the scope of the appended claims, which scope is to be accorded the broadest interpretation so as to encompass all such modifications and equivalent structures as is permitted under the law.

What is claimed is:

1. An LED-based light assembly, comprising:
a plurality of LEDs;
an elongate housing for the LEDs, the housing having an outer surface at least partially defined by a first lens;
a second lens, the second lens removably attachable to the outer surface of the housing such that at least a portion of the second lens overlays the first lens in a spaced relationship; and
at least one connector arranged at an end of the housing, the connector configured for engagement with a socket of a fluorescent light fixture.

2. The LED-based light assembly of claim 1, wherein the second lens has an open cross sectional profile and is resiliently flexible, such that the second lens is configured to be manually forced to an open position for arrangement around the outer surface of the housing, and to be released for attachment to the outer surface of the housing.

3. The LED-based light assembly of claim 2, wherein the second lens has an interior surface and includes at least one tab projecting radially inwardly from the interior surface, with the tab defining a point of attachment to the outer surface of the housing when the second lens is released.

4. The LED-based light assembly of claim 3, wherein:
the housing defines a groove at the outer surface, the groove bordered by an edge,
the second lens includes a pair of spaced tabs projecting radially inwardly from the interior surface, and
the second lens is configured to be released for attachment to the outer surface of the housing in a first attachment position, where the pair of spaced tabs is positioned in the groove, and to be released for attachment to the outer surface of the housing in a second attachment position, where the pair of spaced tabs is positioned on both sides of the edge.

5. The LED-based light assembly of claim 4, wherein the portion of the second lens for overlaying the first lens is further spaced from the first lens with the second lens released for attachment to the outer surface of the housing in the second attachment position compared to when the second lens is released for attachment to the outer surface of the housing in the first attachment position.

6. The LED-based light assembly of claim 1, wherein the second lens is removably attachable to the outer surface of the housing by a friction fit, without using fasteners or adhesives.

7. The LED-based light assembly of claim 1, wherein the portion of the second lens for overlaying the first lens is translucent.

8. The LED-based light assembly of claim 1, wherein the portion of the second lens for overlaying the first lens includes light diffusing ridges.

9. The LED-based light assembly of claim 1, wherein the portion of the second lens for overlaying the first lens includes a reflector.

10. A method of modifying the light diffusion characteristics of an LED-based light with a plurality of LEDs, an elongate housing for the LEDs having an outer surface at least partially defined by a first lens, and at least one connector arranged at an end of the housing configured for engagement with a socket of a fluorescent light fixture, the method comprising:
removably attaching a second lens to the outer surface of the housing, such that at least a portion of the second lens overlays the first lens in a spaced relationship.

11. The method of claim 10, further comprising:
removing the second lens from the outer surface of the housing; and
removably attaching a third lens to the outer surface of the housing, such that at least a portion of the third lens overlays the first lens in a spaced relationship.

12. The method of claim 10, wherein the second lens has an open cross sectional profile and is resiliently flexible, further comprising:
forcing the second lens to an open position;
with the second lens in an open position, arranging the second lens at least partially around the outer surface of the housing; and
with the second lens arranged at least partially around the outer surface of the housing, releasing the second lens for attachment to the outer surface of the housing.

13. The method of claim 12, wherein the second lens has an interior surface and includes at least one tab projecting radially inwardly from the interior surface, further comprising:
arranging the second lens at least partially around the outer surface of the housing, with the at least one tab facing the outer surface of the housing; and
with the second lens arranged at least partially around the outer surface of the housing and the at least one tab facing the outer surface of the housing, releasing the second lens for attachment to the outer surface of the housing, wherein the at least one tab securely engages the outer surface of the housing.

14. The method of claim 10, wherein the housing defines a groove at the outer surface bordered by an edge, the second lens has an open cross sectional profile and is resiliently flexible, and the second lens includes a pair of spaced tabs projecting radially inwardly from the interior surface, further comprising:
forcing the second lens to an open position;
with the second lens in an open position, arranging the second lens at least partially around the outer surface of the housing; and
with the second lens arranged at least partially around the outer surface of the housing, releasing the second lens for attachment to the outer surface of the housing in a first attachment position, where the pair of spaced tabs is positioned in the groove.

15. The method of claim 14, further comprising:
forcing the second lens from the first attachment position to an open position;
with the second lens in an open position, rearranging the second lens at least partially around the outer surface of the housing; and
with the second lens rearranged at least partially around the outer surface of the housing, releasing the second lens for attachment to the outer surface of the housing in a second attachment position, where the pair of spaced tabs is positioned on both sides of the edge.

16. The method of claim 15, wherein the portion of the second lens overlaying the first lens is further spaced from the first lens with the second lens released for attachment to the outer surface of the housing in the second attachment position compared to when the second lens is released for attachment to the outer surface of the housing in the first attachment position.

17. The method of claim 10, wherein the removable attachment of the second lens to the outer surface of the housing is by a friction fit, without using fasteners or adhesives.

18. An LED-based light assembly, comprising:
a plurality of LEDs;
an elongate housing for the LEDs, the housing having an outer surface at least partially defined by a first lens and defining a first groove on a first side of the lens and a second groove on an opposing side of the lens, with the first groove bordered by a first edge of the outer surface and the second groove bordered by a second edge of the outer surface;
a second lens, the second lens having two opposing end portions and an interior surface extending between the two end portions, with first and second opposing pairs of spaced tabs projecting radially inwardly from the interior surface, wherein the second lens is resiliently flexible such that the second lens is configured to be arranged around the outer surface of the housing in at least one of:
a first attachment position, where the first pair of spaced tabs is positioned in the first groove, the second pair of spaced tabs is positioned in the second groove, and at least a portion of the second lens overlays the first lens in a first spaced relationship, or
a second attachment position, the first pair of spaced tabs is positioned on both sides of the first edge, the second pair of spaced tabs is positioned on both sides of the second edge, and at least a portion of the second lens overlays the first lens in a second spaced relationship different from the first spaced relationship; and
at least one connector arranged at an end of the housing, the connector configured for engagement with a socket of a fluorescent light fixture.

19. The LED-based light assembly of claim 18, wherein the second lens is removably attachable to the outer surface of the housing by a friction fit in either the first attachment position or the second attachment position, without using fasteners or adhesives.
